(19) United States
(12) Patent Application Publication
(10) Pub. No.: US 2025/0045595 A1
(43) Pub. Date: Feb. 6, 2025

(54) MACHINE LEARNING MODEL APPLICATION POLICY LAYER

(71) Applicant: Transcend Inc., Covina, CA (US)

(72) Inventors: Benjamin C. Brook, Naples, FL (US); Annalisa Alden, Concord, NC (US); Michael Farrell, Beverly Hills, CA (US)

(21) Appl. No.: 18/792,345

(22) Filed: Aug. 1, 2024

Related U.S. Application Data
(60) Provisional application No. 63/517,044, filed on Aug. 1, 2023.

(51) Int. Cl. G06N 3/092

(52) U.S. Cl. CPC G06N 3/092

(57) ABSTRACT

Methods, systems, and apparatus, including computer programs encoded on computer storage media, for implementing a policy layer for controlling how applications interact with internal or external machine learning models. One of the methods includes receiving an original input from an application. One or more input matching processes are performed to identify one or more matching input policy routines. One or more actions are performed according to the one or more matching input policy routines to generate a modified input. The modified input is provided instead of the original input to the machine learning system.

### CROSS-REFERENCE TO RELATED APPLICATIONS

This application claims the benefit under 35 U.S.C. §119 (e) of the filing date of U.S. Provisional Patent Application No. 63/517,044, filed on Aug. 1, 2023, entitled “MACHINE LEARNING MODEL APPLICATION POLICY LAYER,” the entirety of which is herein incorporated by reference.

### BACKGROUND

This specification relates to cloud computing platforms for machine learning models and associated computing systems.

Many modern machine learning systems implement machine learning models that operate on text inputs and text responses. For example, large language models (LLMs) can generate text responses for a wide variety of purposes. These machine learning systems are becoming increasingly popular to improve the efficiency of various tasks, including writing code, summarizing documentation, and drafting communications, to name just a few examples.

However, the nature of such machine learning systems presents several technical challenges for organizations that use them. As one example, it is common for such machine learning systems to use actual input and response pairs to further refine the underlying model. This presents an opportunity for private, confidential, or other sensitive information to be leaked to other computing systems. In addition, organizations often have no visibility into whether their members are using such systems and to what extent, and it is difficult to audit what data is being sent to or received from such machine learning systems.

Moreover, it is difficult if not impossible to deploy company-wide logic for every application in use on company networks. It is equally difficult to automatically detect problems or issues with data being sent to machine learning systems or data being returned from such systems. As a result, organizations have been reluctant to endorse the use of services providing such machine learning technologies and therefore are unable to realize the associated efficiency improvements they provide.

### SUMMARY

This specification describes a computing system that implements a policy layer for controlling how applications interact with internal or external machine learning models. In particular, the policy layer can apply a comprehensive set of policies to all communications with particular machine learning systems.

In this specification, a policy is a collection of data that specifies one or more matching conditions and one or more policy routines, which are software modules to be performed on input or responses for a machine learning system. A policy can be an input policy that is applied to inputs of the machine learning system, in which case the policy routines perform one or more modifications on the input in order to generate a modified input. A policy can also be a response policy that is applied to responses of the machine learning system, in which case the policy routines perform one or more modifications on the responses in order to generate a modified response. The inputs and responses can be in any appropriate format depending on the configuration of the machine learning system. For example, the inputs and responses can be text, images, audio, electronic files, or some combination of these, to name just a few examples.

The techniques described in this specification can be used with any appropriate machine learning system. One example of a suitable machine learning system is a system that implements a large language model (LLM). In this specification, a large language model is a machine learning system that uses one or more transformer layers to autoregressively transform an input sequence using self-attention. A large language model can be implemented using encoders, decoders, or a combination of these. However, the techniques described in this specification can also be used with other machine learning systems that implement other kinds of machine learning models, e.g., machine learning systems that accept image inputs to generate text or vice versa.

Additional applications can be used to evaluate the machine learning systems themselves. For example, an application can use the policy layer to perform algorithmic bias assessments in order to run tests of certain biases. As another example, an application can use the policy layer to interrogate previously observed conversations in order to generate an explainability or interpretability evaluation.

Particular embodiments of the subject matter described in this specification can be implemented so as to realize one or more of the following advantages. By implementing the policy layer described in this specification, organizations can retain full control and visibility of how applications and teams are using machine learning systems inside or outside of the organization. The customization of the policy sets allows teams within the organization to realize the efficiency gains of machine learning systems while reducing or eliminating the risk of data leaks or code contamination. The policy layer can provide a singular choke point for data in and out of machine learning systems. The policy layer is easily extensible, which allows teams to customize deployments to meet current and future architecture needs. The policy layer also provides a singular window for monitoring and audit risks and usage of machine learning models. The extensible nature of the policy layer accommodates custom rules and behaviors, while off-the-shelf policy packs make it simple to get started with best practice governance policies. In addition, the policy layer provides evidential proof of machine learning governance measures that can be used with business customers and partnerships. Moreover, the techniques described in this specification greatly simplify the technical challenge of adopting machine learning models to perform tasks. In addition, it becomes easier and less risky to add new client applications that use machine learning systems.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example computing system using a policy layer.

FIG. 2 is a flowchart of an example process for generating a modified input to a machine learning system.

FIG. 3 is a flowchart of an example process for installing a policy layer for a particular entity.

FIG. 4 shows an example of using a policy layer to monitor the interactions between multiple applications and multiple machine learning systems.

FIG. 5 shows an example of storing received text inputs in an audit log.

Like reference numbers and designations in the various drawings indicate like elements.

### DETAILED DESCRIPTION

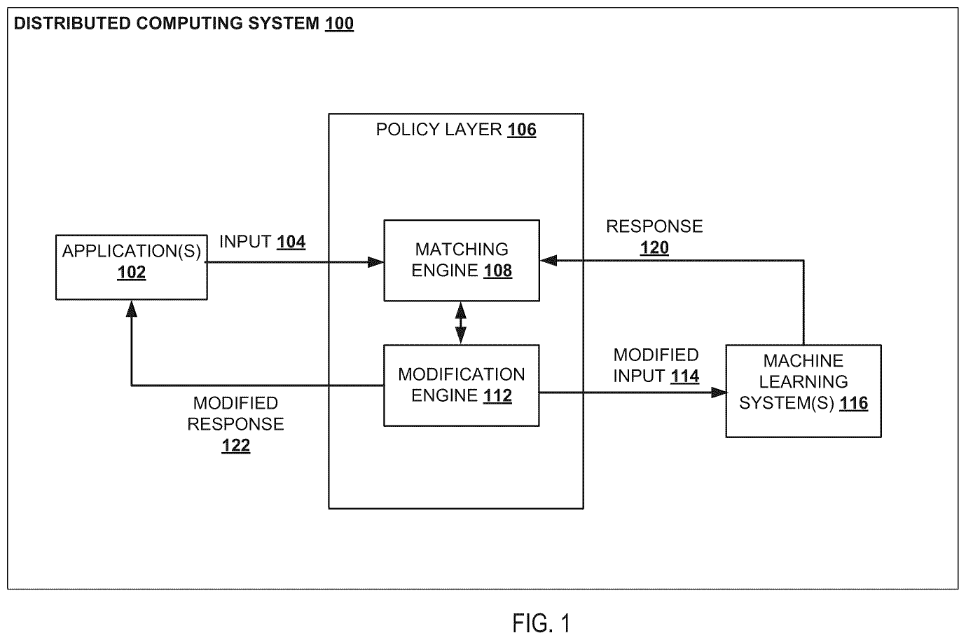

FIG. 1 is a block diagram of an example computing system 100 using a policy layer 106. The computing system includes one or more applications 102, a policy layer 106, and one or more machine learning systems 116. The architecture of the system 100 situates the policy layer 106 between the applications 102 and the machine learning systems 116 and allows data to flow according to predefined policies. This arrangement allows enhanced control and oversight of the data.

The one or more applications 102 can be, for example, an word processing application, a code writing programming, such as an integrated development environment, an instant messaging application, a chat box application, an email application, a gaming application, or a search application, to name just a few examples.

The policy layer 106 includes an input matching engine 108 and a modification engine 112. Each of these engines can be implemented as software subsystems executing on one or more computers in one or more locations.

The input matching engine 108 can receive an input 104 from the one or more applications 102 and can process the input 104 according to one or more input matching processes to identify one or more matching input policy routines 110. The input 104 can be in any appropriate format depending on the configuration of the one or more machine learning systems 116. For example, the input can be text, images, audio, electronic files, or some combination of these, to name just a few examples.

In this specification, a policy is a collection of data that specifies one or more matching conditions and one or more policy routines, which are software processes that will be performed on input or responses for a machine learning system 116. A policy can be an input policy that is applied to inputs of the machine learning system, in which case the policy routines perform one or more modifications on the input in order to generate a modified input.

The modification engine 112 can perform one or more actions according to one or more matching input policy routines to generate a modified input 114. The modification engine 112 can provide the modified input 114 instead of the original input 104 to the one or more machine learning systems 116.

The system can similarly use policy matching and modifications for responses of machine learning systems 116. For example, the policy layer 106 can receive a response 120 from the machine learning system 116 and use the matching engine 108 to determine one or more modifications to be performed by one or more policy routines. The modification engine 112 can then generate a modified response 122 that is provided back to the application 102 as a response to its original input 104, which may or may not have undergone modifications as well. The modified response 122 can be in any appropriate format depending on the configuration of the one or more machine learning systems 116. For example, the response can be text, images, audio, electronic files, or some combination of these, to name just a few examples.

While the policy layer 106 can be used by reconfiguring existing applications, the policy layer 106 can also be used as a foundation for building applications that use the policy layer natively to communicate with machine learning systems. As one example, an organization can provide an LLM application that natively uses the policy layer 106. For example, the LLM application can be a chat bot that communicates through the policy layer 106 with an internal or external machine learning system 116.

Additional applications can be used to evaluate the machine learning systems themselves. For example, an application can use the policy layer 106 to perform algorithmic bias assessments in order to run tests of certain biases. As another example, an application can use the policy layer 106 to interrogate previously observed conversations in order to generate an explainability or interpretability evaluation.

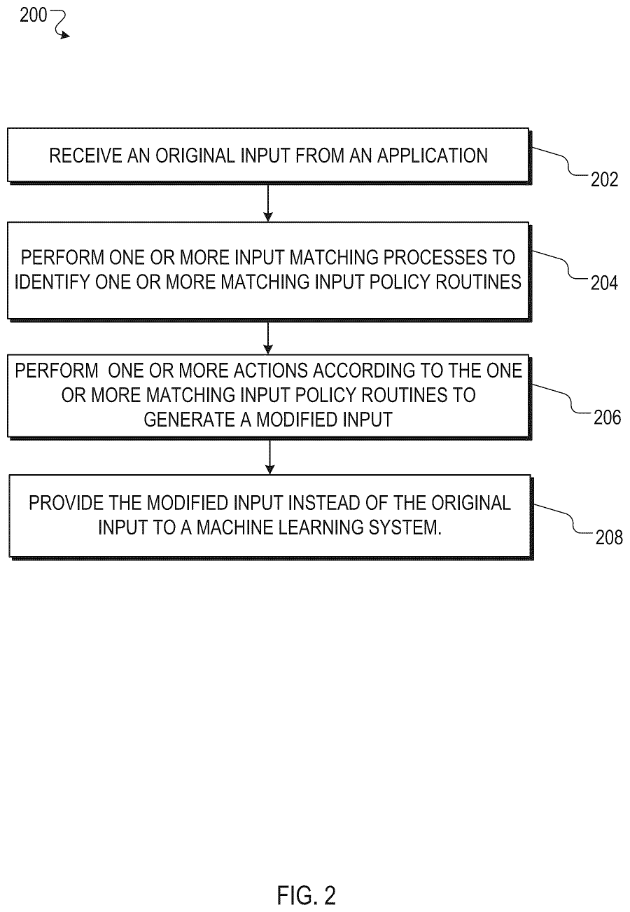

FIG. 2 is a flow chart of an example process 200 for generating a modified input to a machine learning system. The process 200 can be executed by a distributed computing system comprising one or more computers in one or more locations, for example, by the example computing system 100 of FIG. 1. The process will be described as being performed by a system of one or more computers.

The system receives from an application an original input for a machine learning system (202). The original input can be in any appropriate format e.g., text, images, audio, electronic files, or some combination of these, to name just a few examples.

The system can perform one or more input matching processes to identify one or more matching input policy routines (step 204). The matching input policy routines are software modules to be performed on input for a machine learning system.

The system can perform one or more actions according to the one or more matching input policy routines to generate a modified input (step 206). In some implementations, performing the one or more actions includes removing one or more text elements from the original text input. In some implementations, the system can substitute replacement text for the one or more removed text elements in the modified text input. The system can receive an original text response from the machine learning system and determine that the original text response includes the replacement text. The system can substitute the one or more removed text elements in place of the replacement text to generate a modified text response. In some implementations, this substitution process is transparent to the application in that the application is not notified that the substitution has taken place.

The input matching policy routines can include scanning the input for sensitive data. For example, the system can scan the input for personally identifiable information (i.e., health records, financial data, etc.) and redact the personally identifiable information as necessary. As a particular example, the system can replace credit card numbers in the text input with a pseudorandomly generated number. The system can also scan the input for certain predefined keywords or phrases and alert an organization when these keywords and phrases appear in the input. The system can also scan the input for non-brand compliant information (e.g., a chat bot that is restricted from using specific words), including harmful information. Each organization can choose a custom combination of input matching policy routines that align with the workflows and requirements of the specific organization.

The system can provide the modified input instead of the original input to a machine learning system (step 208). Alternatively or in addition, the system can block the input from reaching the machine learning system altogether. The system can optionally provide a notification to the application that the input was blocked.

The machine learning system can implement a machine learning model having multiple model parameters. The machine learning system can be configured to refine the model parameters with input received from one or more applications. Generating the modified input can prevent a particular type of input (e.g., a credit card number) from being used to refine the plurality of model parameters.

In some implementations, the system can receive, from the machine learning system, a response corresponding to the modified input and provide the received response to the application.

The system can also identify matching response policy routines to perform one or more modifications on responses of the machine learning system in order to generate a modified response. In some implementations, the system can receive an original response from the machine learning system. The system can then perform one or more response matching processes to identify one or more matching response policy routines and perform one or more actions according to the one or more matching response policy routines to generate a modified response. The system can then provide the modified response instead of the original response to the application. In some examples, the machine learning system is configured to generate responses that are based on inputs received from other applications. Generating the modified response can prevent a particular type of response (e.g., a credit card number) from reaching the application.

The response matching policy routines can include scanning the input for sensitive data. For example, the system can scan the response for personally identifiable information (i.e., health records, financial data, etc.) and redact the personally identifiable information as necessary. As a particular example, the system can replace credit card numbers in a text response with a fake number. The system can also scan the response for certain predefined keywords or phrases and alert an organization when these keywords and phrases appear in the response. As a particular example, if health data is inadvertently exposed, the system can alert the organization so that the organization can take immediate action. The system can also scan the response for non-brand compliant information (e.g., a chat bot that is restricted from using specific words), including harmful information.

In some implementations, the system blocks the response from reaching the application altogether. The system can instead generate an error message to indicate that the response from the machine learning system was blocked. For example, the system can determine that the response included copyrighted information, e.g., copyrighted source code, by performing a copyright analysis check on the response. The system can then block the response entirely rather than modifying the response.

The system can store received text inputs and outputs in audit logs. In some implementations, the system can store each received original text input in an audit log or provide each received original text input to an auditing subsystem. In some examples, the system can store each received original input in the audit log in association with a respective modified input generated according to one or more input policy routines. The system can store each received original input in the audit log in association with a respective response generated by the machine learning system.

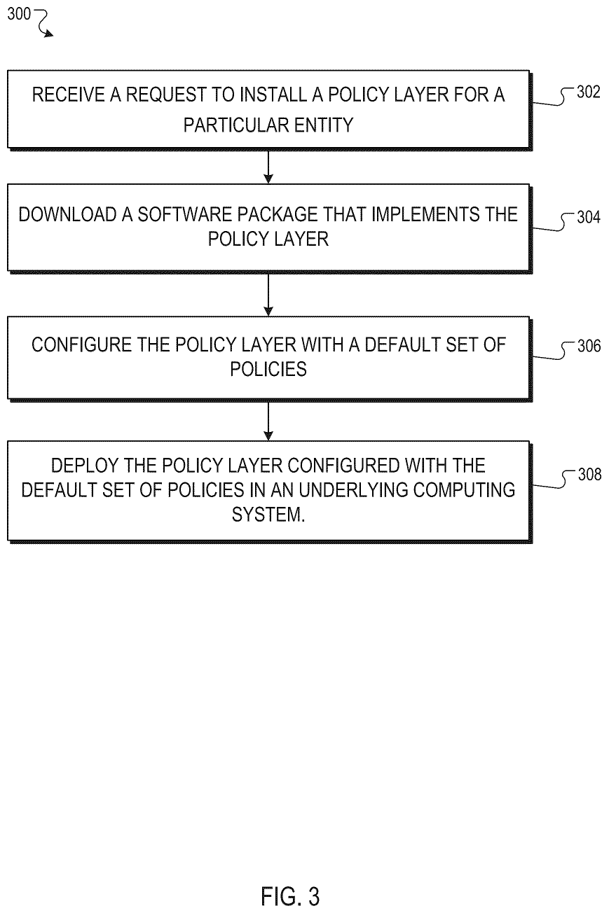

FIG. 3 is a flow chart of an example process 300 for installing a policy layer for a particular entity. The process 300 can be executed by a computing system, such as the computing system 100 of FIG. 1, or a portion thereof.

The system can receive a request to install the policy layer for a particular entity (step 302). A policy is a collection of data that specifies one or more matching conditions and one or more policy routines, which are software modules to be performed on input or responses for a machine learning system.

The system can download a software package that implements the policy layer (step 304). The software package can be, for example, a container image.

The system can configure the policy layer with a default set of policies (step 306). The system can execute one or more scripts to inject policy routines into the policy layer. When the software package is a container image, the system can deploy a container based on the container image and inject policy routines into the container.

The system can deploy the policy layer configured with the default set of policies in an underlying computing system (step 308).

The system can configure the policy layer with an additional set of entity-specific policies. In some implementations, the system can deploy the policy layer in the underlying computing system by deploying the policy layer with the default set of policies and the additional set of entity-specific policies.

The system can configure the policy layer with an additional set of application-specific policies. In some implementations, the system can deploy the policy layer in the underlying computing system by deploying the policy layer with the default set of policies and the additional set of application-specific policies. The policy layer can be configured to apply the application-specific policies only to particular applications among multiple applications that use the machine learning system.

The system can use a policy layer key to monitor external requests. In some implementations, the system can monitor external requests to network locations associated with external machine learning systems. The system can disallow external requests that are not associated with a policy layer key. In some implementations, the system can receive, from the application, an external request to a network location associated with an external machine learning system. The system can determine that the application has a policy layer key and in response, apply one or more policy routines associated with the application.

The application can be configured to use a third-party service that uses the machine learning system. In some implementations, the system can provide, to the third-party service, configuration information for the policy layer. The configuration information can cause the third-party service to access the machine learning system through the policy layer.

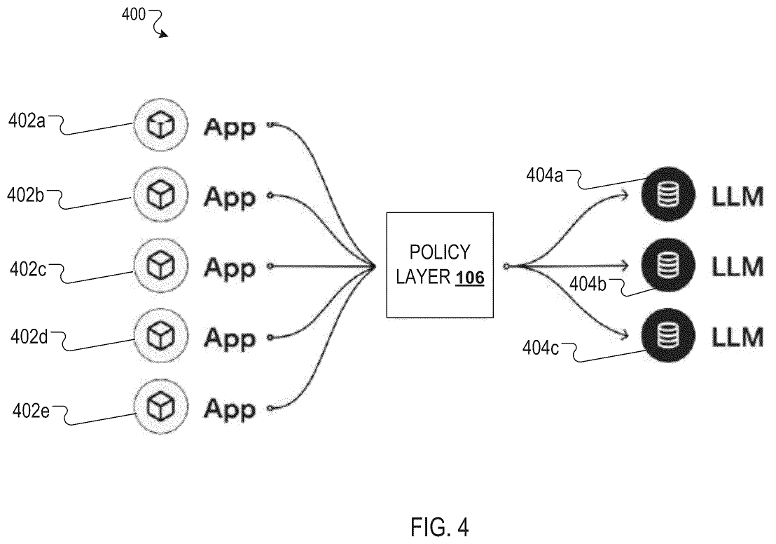

FIG. 4 shows an example 400 of using a policy layer 106 to monitor the interactions between multiple applications 402a-e and multiple machine learning systems 404a-c.

In a large organization, there may be hundreds of applications 402a-e, each potentially connected to multiple machine learning systems 404a-c. Maintaining direct integrations can lead to a complex system that is challenging to manage and secure. A centralized architecture that implements the policy layer 106 simplifies governing the data exchanged between applications 402a-e and machine learning systems 404a-c. Instead of each application interacting directly with a machine learning system, communication is funneled through the policy layer 106. This makes it easy to deploy a new policy across all applications and the architecture can be deployed in a semi-centralized way.

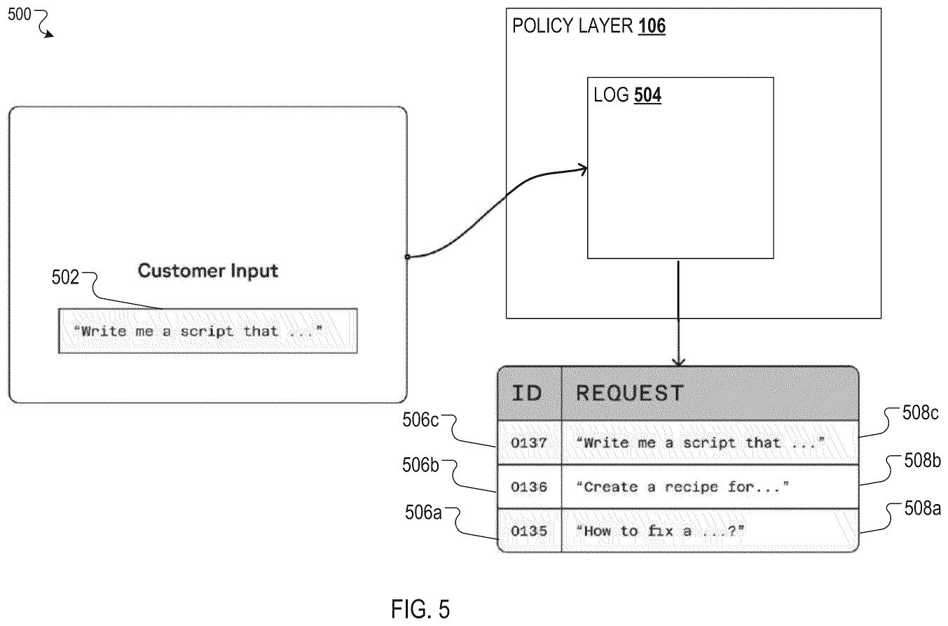

FIG. 5 shows an example 500 of storing received text inputs in an audit log. The policy layer 106 receives a text input 502 that reads “Write me a script that . . . ”. The policy layer 106 includes an audit log 504 that stores input ID numbers 506a-c (e.g., 0135, 0136, 0137) and the respective text inputs 508a-c (e.g., “How to fix a . . . ?”, “Create a recipe for . . . ”, “Write me a script that . . . ”).

An organization can use an audit log to track interactions with machine learning systems. The audit log can provide detailed usage histories and allow an organization to scrutinize how machine learning systems are used. An organization can use the audit log 504 during incident response, when evaluating bias, and for achieving interpretability in order to identify what leads to a problem and how to prevent recurrence of the problem.

In some implementations, the system can store each received original text input in an audit log or provide each received original text input to an auditing subsystem. In some examples, the system can store each received original input in the audit log in association with a respective modified input generated according to one or more input policy routines. The system can store each received original input in the audit log in association with a respective response generated by the machine learning system.

Alternatively or in addition to the embodiments described above, in some implementations the system can provide user interface presentations that include one or more dashboards to visualize or filter the audit logs and to define policies from a dashboard instead of from code. Additionally we did add some monitoring capabilities to understand this information on a per end user or per application basis.

In addition, the system can support some policies that are dynamic in the sense that they are specific to individual users. For example, a first user can provide consent to a certain operation that may allow a request to go through, while users who have not provided consent may have such inputs blocked. For example, some applications may be allowed to process social security numbers, but others may not.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, subprograms, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1. A distributed computing system comprising a plurality of computers and one or more storage devices storing instructions that are operable, when executed by one or more of the plurality of computers, cause the system to implement a plurality of subsystems comprising:
an application configured to communicate with a machine learning system that is configured to receive input and to generate responses; and
a policy layer that is configured to perform operations comprising:
receiving an original input from the application,
performing one or more input matching processes to identify one or more matching input policy routines,
performing one or more actions according to the one or more matching input policy routines to generate a modified input, and
providing the modified input instead of the original input to the machine learning system.

2. The system of claim 1, wherein the operations further comprise receiving, from the machine learning system, a response corresponding to the modified input and providing the received response to the application.

3. The system of claim 1, wherein the operations further comprise:
receiving an original response from the machine learning system;
performing one or more response matching processes to identify one or more matching response policy routines;
performing one or more actions according to the one or more matching response policy routines to generate a modified response; and
providing the modified response instead of the original response to the application.

4. The system of claim 1, further comprising storing each received original text input in an audit log or providing each received original text input to an auditing subsystem.

5. The system of claim 4, further comprising storing each received original input in the audit log in association with a respective modified input generated according to one or more input policy routines.

6. The system of claim 4, further comprising storing each received original input in the audit log in association with a respective response generated by the machine learning system.

7. The system of claim 1, wherein the machine learning system implements a machine learning model having a plurality of model parameters, and wherein the machine learning system is configured to refine the plurality of model parameters with input received from one or more applications.

8. The system of claim 7, wherein generating the modified input prevents a particular type of input from being used to refine the plurality of model parameters.

9. The system of claim 3, wherein the machine learning system is configured to generate responses that are based on inputs received from other applications.

10. The system of claim 9, wherein generating the modified response prevents a particular type of response from reaching the application.

11. The system of claim 1, wherein the plurality of subsystems comprises an installation subsystem that is configured to perform operations comprising:
receiving a request to install the policy layer for a particular entity
downloading a software package that implements the policy layer;
configuring the policy layer with a default set of policies; and
deploying the policy layer configured with the default set of policies in an underlying computing system.

12. The system of claim 11, further comprising configuring the policy layer with an additional set of entity-specific policies, wherein deploying the policy layer in the underlying computing system comprises deploying the policy layer with the default set of policies and the additional set of entity-specific policies.

13. The system of claim 11, further comprising configuring the policy layer with an additional set of application-specific policies, wherein deploying the policy layer in the underlying computing system comprises deploying the policy layer with the default set of policies and the additional set of application-specific policies,
wherein the policy layer is configured to apply the application-specific policies only to particular applications among a plurality of applications that use the machine learning system.

14. The system of claim 11, wherein configuring the policy layer comprises:
executing one or more scripts to inject policy routines into the policy layer.

15. The system of claim 14, wherein the software package is a container image, and wherein configuring the policy layer comprises deploying a container based on the container image and injecting policy routines into the container.

16. The system of claim 1, wherein the operations further comprise:
monitoring external requests to network locations associated with external machine learning systems; and
disallowing external requests that are not associated with a policy layer key.

17. The system of claim 16, wherein the operations further comprise:
receiving, from the application, an external request to a network location associated with an external machine learning system;
determining that the application has a policy layer key; and
in response, applying one or more policy routines associated with the application.

18. The system of claim 1, wherein the application is configured to use a third-party service that use the machine learning system, wherein the operations further comprise:
providing, to the third-party service, configuration information for the policy layer, wherein the configuration information causes the third-party service to access the machine learning system through the policy layer.

19. The system claim 1, wherein performing the one or more actions comprises removing one or more text elements from the original text input, and wherein the operations further comprise performing a substitution process comprising:
substituting replacement text for the one or more removed text elements in the modified text input;
receiving an original text response from the machine learning system;
determining that the original text response includes the replacement text; and
substituting the one or more removed text elements in place of the replacement text to generate a modified text response.

20. The system of claim 19, wherein the substitution process is transparent to the application.

21. The system of claim 1, wherein the application is an application that is configured to natively communicate with the machine learning system using the policy layer.

22. The system of claim 21, wherein the application is an LLM chat bot application that communicates with an LLM through the policy layer.

23. The system of claim 21, wherein the application is configured to perform one or more algorithmic bias assessments.

24. The system of claim 21, wherein the application is configured to generate an explainability or interpretability evaluation of the machine learning system.
